(19) United States
(12) Patent Application Publication
(10) Pub. No.: US 2006/0123080 A1
(43) Pub. Date: Jun. 8, 2006

(54) Method and system of collectively setting preferences among a plurality of electronic devices and users

(75) Inventors: Daniel A. Baudino, Lake Worth, FL (US); Deepak P. Ahya, Plantation, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/003,960

(22) Filed: Dec. 3, 2004

(51) Int. Cl. G06F 15/16; G06F 15/177

(52) U.S. Cl. 709/204; 709/221

(57) ABSTRACT

A system (30) and method (60, 70, and 90) of collectively setting preferences among a plurality of electronic devices (devices #1, #2, and #3) includes collecting user preference data independently by at least two among the plurality of electronic devices, exchanging (67, 76, 84, 97) the user preference data among the electronic devices when at least two among the electronic devices are within a predetermined proximity, forming a group user profile from the user data exchanged, and arbitrating (102-126) the parameters and settings in at least one among the electronic devices in accordance with the group user profile. Arbitrating can include averaging (116) the parameters and settings, maintaining (126) an existing parameter and setting, matching (120 or 124) parameters and settings to parameters and settings of certain ones of the plurality of electronic devices, or adjusting (106) parameters and settings based on parameters and settings stored on a shared database.

### FIELD OF THE INVENTION

This invention relates generally to portability, and more particularly to a method and system for setting preferences among devices collectively.

### BACKGROUND OF THE INVENTION

Seamless mobility in the contexts of today's electronic devices seem to fail to address beyond content and session handling. A personal digital assistant can synchronize its data among several computers, but each portable device typically fails to account for a user's unique preferences and habits over a different context in terms of time, location, availability of user devices or in terms of the presence of other devices/users, or device capabilities.

A user of a mobile device can be engaged in various different contexts in relation to other devices or in relation to other users (of such devices) within a proximity of the user. Although devices exist that can merely transfer data from one device to another, such devices usually fail to account for a new context or environment in which the user can be set in. Furthermore, such devices typically fail to account for dynamic changes in context in terms of group membership or in terms of individual preferences by the individual members of a group.

### SUMMARY OF THE INVENTION

Embodiments in accordance with the present invention can provide a means to create an enhanced universal access and experience by learning from users and their interaction with devices.

In a first embodiment of the present invention, a method of collectively setting preferences among a plurality of electronic devices and a plurality of users can include the steps of collecting user preference data independently by the at least two among the plurality of electronic devices, exchanging the user preference data among the plurality of electronic devices when at least two among the plurality of electronic devices are within a predetermined proximity, forming a group user profile (such as a common group user profile) from the user data exchanged, and arbitrating the parameters and settings in at least one among the plurality of electronic devices in accordance with the group user profile. Note, the parameters and settings can be arbitrated in many different ways in accordance with embodiment of the present invention including, but not limited to averaging the parameters and settings, maintaining an existing parameter and setting, matching parameters and settings to parameters and settings of one among the plurality of electronic devices, adjusting the parameters and settings based on parameters and settings stored on a shared database among the plurality of electronic devices, or learning what parameters and settings a particular user prefers and replicating said parameters and settings when the plurality of electronic devices are within a predetermined proximity. Note, the step of collecting user preference data independently forms an individual user profile and the step of arbitrating the parameters and settings in one embodiment can provide a preference to the group user profile formed over the individual user profile. Collecting user preference data can include collecting at least one among user content preferences, user habit preferences, user source preferences, or user device feature preferences. Collecting user preference data can further include the step of collecting at least one among movie preferences, video series preferences, actor or actress preferences, movie producer preferences, movie studio preferences, volume preference, network preferences, user taste preferences, song preferences, radio station preferences, singer preferences, band preferences, music style preferences, web site preferences, temperature preferences, alarm setting preferences, chat buddies, and email list preferences.

The step of forming the group user profile can include the step of creating rules for a predetermined group of users and in particular embodiments, the rules are created for the predetermined group by using at least one among pre-configured rules by a user, learned rules from prior interactions between users, default rules, and exchanged profiles among users. The method can further include the step of detecting a group by exchanging identifiers and profiles. The method can further store the identifier and a relationship associated with a user in a phone book for example. Then, the step of detecting the group can further include identifying users in the phonebook having at least one among devices sharing a similar profile, settings from a past group encounter, or settings in a profile for an identified group.

In a second embodiment of the present invention, an electronic device capable of setting preferences among a plurality of electronic devices collectively can include a processor coupled to the electronic device. The processor can be programmed to collect user preference data independently among the plurality of electronic devices, exchange the user preference data among the plurality of electronic devices when at least two among the plurality of electronic devices are within a predetermined proximity, form a group user profile from the user data exchanged, and arbitrate the parameters and settings in at least one among the plurality of electronic devices in accordance with the group user profile. The processor can arbitrate the parameters and settings by performing at least one among averaging the parameters and settings, maintaining an existing parameter and setting, matching parameters and settings to parameters and settings of one among the plurality of electronic devices, adjusting the parameters and settings based on parameters and settings stored on a shared database among the plurality of electronic devices, learning what parameters and settings a particular user prefers and replicating said parameters and settings when the plurality of electronic devices are within a predetermined proximity or manually adjusting the parameters and settings. The processor can form the group user profile by creating rules for a predetermined group of users and more particularly in several embodiments the processor can form the group user profile by creating rules for the predetermined group of users by using at least one among pre-configured rules by a user, learned rules from prior interactions between users, default rules, and exchanged profiles among users. The processor in this regard can be programmed to adjust the behavior of the electronic device based on a presence of another electronic device among the plurality of electronic devices and on a relationship with a user thereof.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a seamless portability system in accordance with an embodiment of the present invention.

FIG. 2 is block diagram of a profile manager that can be used in the seamless portability system of FIG. 1 in accordance with an embodiment of the present invention

FIG. 3 is a data flow chart illustrating a method of providing seamless portability in accordance with an embodiment of the present invention.

FIG. 4 is a flow chart illustrating a method at a first device for collectively setting preferences among a plurality of electronic devices in accordance with an embodiment of the present invention.

FIG. 5 is a flow chart illustrating a method at a second device of collectively setting preferences among a plurality of electronic devices in accordance with an embodiment of the present invention.

FIG. 6 is a flow chart illustrating a method at a third device of collectively setting preferences among a plurality of electronic devices in accordance with an embodiment of the present invention.

FIG. 7 is a flow chart illustrating a method of arbitrating parameters and settings among a plurality of electronic devices in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments in accordance with the present invention enable a framework for collecting user preferences and habits within each context from multiple electronic devices used by a user. The capabilities of the device (in use) in conjunction with preferences and habit information are used to create enhanced access and experience for the user. Embodiments herein focus on collecting & sharing learning from multiple devices and using this new shared learning to enhance an overall experience on all devices and user surroundings.

The learning at each device can include a myriad of types of information including:

1. Favorite media type (per device or all devices)

2. Favorite websites

3. User Interface preferences

4. Desired Interaction Styles

5. Environment preferences

6. Earpiece/Speaker Distance-Volume Rules

7. Contacts

8. Knowledge of User Personal Data locations (server vs. other devices)

9. User Custom or frequently used profiles

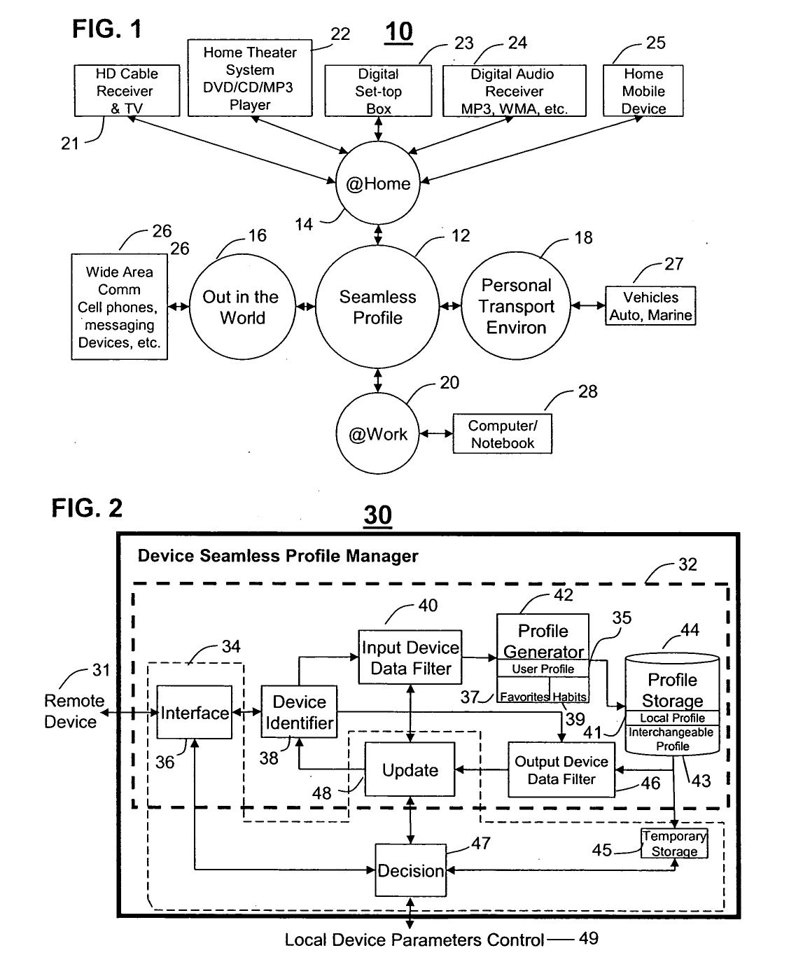

Referring to FIG. 1, a framework 10 is shown that provides “Seamless Learning Portability” among multiple user devices to work together to enhance their respective user interfaces and overall experience among several different contexts or environments. The different environments or contexts can include a home environment 14, a work environment 20, a personal transport environment 18 or an outdoor environment 16. The home environment 14 can include among a high definition (HD) receiver or television 21, a home theater system 22 having DVD or CD or MP3 players or recorders, a digital set-top box 23, a digital audio receiver 24 or a home mobile device 25 such as a remote controller or other similar device. The work environment 20 can include desktop or laptop computers 28, the outdoor environment 16 can include wide area networked communication devices 26 such as cell phones, messaging device or wireless LAN device, and the personal transport environment can include navigation systems, communication, entertainment and telematic devices 27 that might be incorporated in a vehicle. Each device can collect data over time independently from each other. When one device is in proximity of another device, the data can be exchanged between such devices over a wireless LAN or other wireless network. Such data can be stored on each device where each device stores the information that belongs to it and interchanges with other devices when requested. The parameters of the complete profile created based on the user learning can then be exchanged among similar devices creating a seamless learning/profile exchange network 12. As noted examples above, devices providing media content such as TV's, HD cable receivers, digital set-top boxes, home theater systems can contribute to the seamless profile/learning portability aspects herein by collecting and providing a user's favorites/preferences in a list of movies, TV series etc., or a user's habits (volume, network selected, etc), or a user's preferred features (from the device), or a user's taste and watching behaviors, or a profile based on all the information collected from the user. In terms of a home theater system (CD Player, DVD Player, MP3, etc.), such devices that play this type of media can collect a user's favorites or preferences list of songs, radio stations, etc., collect a user's habits (volume, station selected, etc), collect a user's preferred features (from the device), collect user's taste and listening behaviors, or create a profile based on all the information collected from the user. In a computer device such as a desktop or notebook that can also play all types of media (movies, songs, etc) and have the ability to download music, movies, and other data, such a system can collect and track all media played and generate favorites/preferences for media played (songs, movies, etc.), collect user's habits (volume, music web sites used, etc), collect user's preferred media applications, features, media, media web sites, etc., or create profiles of user's taste and listening/watching behaviors. In a vehicle such as an automotive environment, a profile and user habits can be tracked, created and stored by collecting information regarding the stations or artists listened to on a radio or CD, configurations for car temperature, seat positions, and other settings encountered in an automotive environment. With handheld devices (mobile phones, Wireless IM, PDA, etc), such devices can store and collect information related to media, UI, location, chat buddies, or other information in forming a profile based on the user behavior. Similarly, a security system or home monitoring system can control and track temperature, alarm settings and other user information that can also be used to form a profile to enhance a users experience.

Referring to FIG. 2, a high-level architecture diagram of the profile manager 30 is shown that can reside on each type of device in the framework 10 (see FIG. 1). The profile manager 30 can include a first area 32 that can include all the profile generation/interchange architecture and a second area 34 used for requesting control of the parameters of the (local) device based on the profile/information received.

The first area 32 can include a interface module 36 that abstracts all types of short range communications (Bluetooth, WLAN, Zigbee™ or IEEE 802.15.4, etc) to the rest of the profile manager, a device identifier 38 that identifies a remote device 31 and identifies the data that can be shared (not necessarily between just the local device and the remote device, but amongst many or all devices in the framework 10). The first area 32 can further include an input device data filter 40 that filters and sends appropriate information (filtered to match the local device) to a profile generator 42. The profile generator 42 creates a user profile 35, habits (list) 39, favorites (list) 37, and other information that can be used in a profile. The first area 32 can also include an output device filter 46 that sends appropriate information (filtered to match the local device) to a Update module 48. The Update module 48 detects what needs to be updated (what is new to be updated on the remote device). Coupled between the profile generator 42 and the output device filter 46 and included in the first area 32 is a profile storage 44 having for a local profile 41 and an interchangeable profile 43.

The second area 34 also includes and shares with the first area 32 the interface module 36 and the Update module 48. The update module 48 in this regard can be used in controlling both the local (or local device parameter controls 49) and remote device 31 in conjunction with a decision module 47. For example, the update module 48 can update a temperature reading from the remote device 31 to the local device (or another remote device). The decision module 47 indicates to remote device 31 and/or local device to take action (i.e., change volume settings, change temperature settings, etc.). The second area 34 can further include a temporary storage 45 that stores only the data interchanged and generally not data that is part of the profile (latest temperature readings, etc). The data in the temporary storage 45 generally expires (particularly if the local device did not find any other remote device that takes the temperature for example).

Below are examples of tables and information that can be used in an individual user's profile or a group user profile:

Information Collected:

| Attribute | Description |
|---|---|
| Entry ID | Event ID |
| Type | Type associated to the entry (type of media, email, etc) |
| Action | Action performed on the type entry (play, |
| | record, edit, read, write) |
| Location | Coordinates from which the action was executed. |
| Time and Date | Time and date from which the action was executed. |
| Duration/status | Length of the event, played/recorded in full, etc. |

With the collection of above, the following information can be classified:

Entertainment Favorites:

| Attribute | Description | | | |
|---|---|---|---|---|
| Type | Media (Movie, songs), UI (shortcuts) | | | |
| Source | Media source: Cable, Satellite, CD, Downloaded | | | |
| | (URL of the dire is stores separately), etc. | | | |
| Genre | Media genre. | | | |
| Location | Coordinates of the favorite list | | | |
| Time and Date | Time and Date of the creation | | | |
| Last entry | Time and Date of the last entry | | | |
| List Items | Entries on the favorite lists | | | |
| User Profile | Type | Music, | Profile | Like, Dislike, |
| | | Movies, etc | | taste, etc. |

User's Habits:

| Attribute | Description | | | |
|---|---|---|---|---|
| Environment | Volume, temperature | | | |
| Preferences | | | | |
| Location | Habit Coordinates | | | |
| User Profile | Type | Media, | Profile | Like/dislike/Genre associated |
| | | UI, etc. | | with the type most used items, |
| | | | | time of the most used items, etc |

User Interface:

| Attribute | Description | | | |
|---|---|---|---|---|
| Feature | Applications used, frequency, etc | | | |
| Preference | | | | |
| Learning | History, UI usage. | | | |
| Profile | | | | |
| Location | Habit Coordinates | | | |
| User Profile | Type | Media, | Profile | Like/dislike/Genre associated |
| | | UI, etc. | | with the type most used items, |
| | | | | time of the most used items, etc |

From the learning in the form of collected data in tables as illustrated above, user profiles corresponding to location and time, interaction sensitive profiles are created. The information collected, the profile generated as well as favorite lists can be interchanged upon device request.

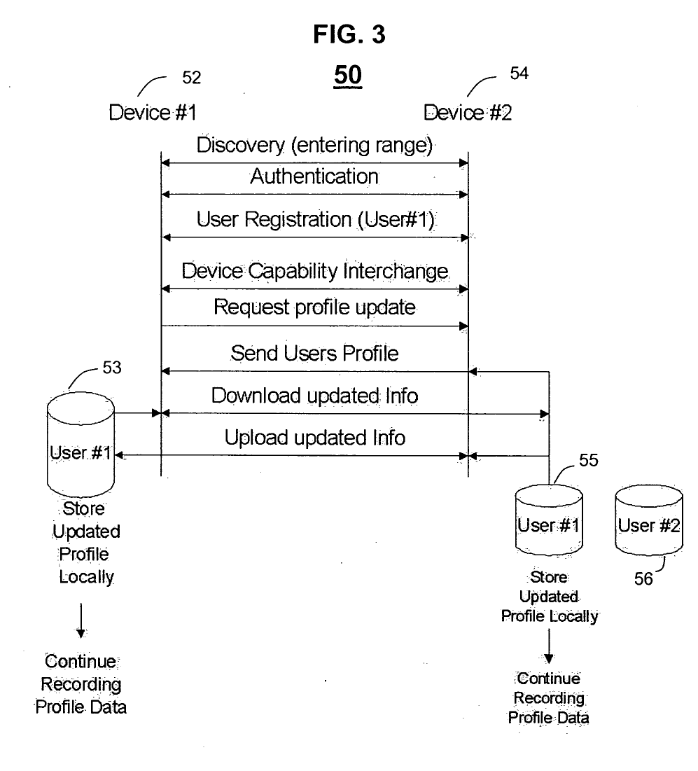

The manner in which information or profiles are interchanged is further illustrated with reference to the data flow diagram 50 of FIG. 3. The interchange can take the form of a peer to peer device profile interchange among a first device 52 having a first user profile 53 and a second device 54 having a first user profile 55 as well as an optional second user profile 56. More specifically, once the devices are within a predetermined proximity or range (using Bluetooth, WLAN, Zigbee™ or IEEE 802.15.4, etc) of each other, they are in discovery and can start interchanging information. Both devices can authenticate by interchanging the device certificates for example. After a successful authentication, the user can register since it can be a multiple user device (as illustrated with the two user profiles for the second device 54). The registration can be done automatically without user intervention. After successful registration, the devices (52 and 54) can interchange their capabilities and settings (device type, data type accepted for the device, profile type) information. The capabilities interchange is particularly useful for both devices in determining what type of profile/data to interchange. In one embodiment, once all the data is interchanged, one of the devices (in this example, device 52) takes master ownership and requests a profile from the other device 54 (time stamped profile/parameters). Once the master device (52) gets the information (parameters/profiles), the device 52 can generate difference from what is stored locally and send it to the other device 54. After all the data is downloaded successfully, the master device 52 starts sending its own profile to the other device. Once all the data is updated, then both devices can start using the new parameters/profile and can update the respective User interfaces, favorites, etc. on each of the devices.

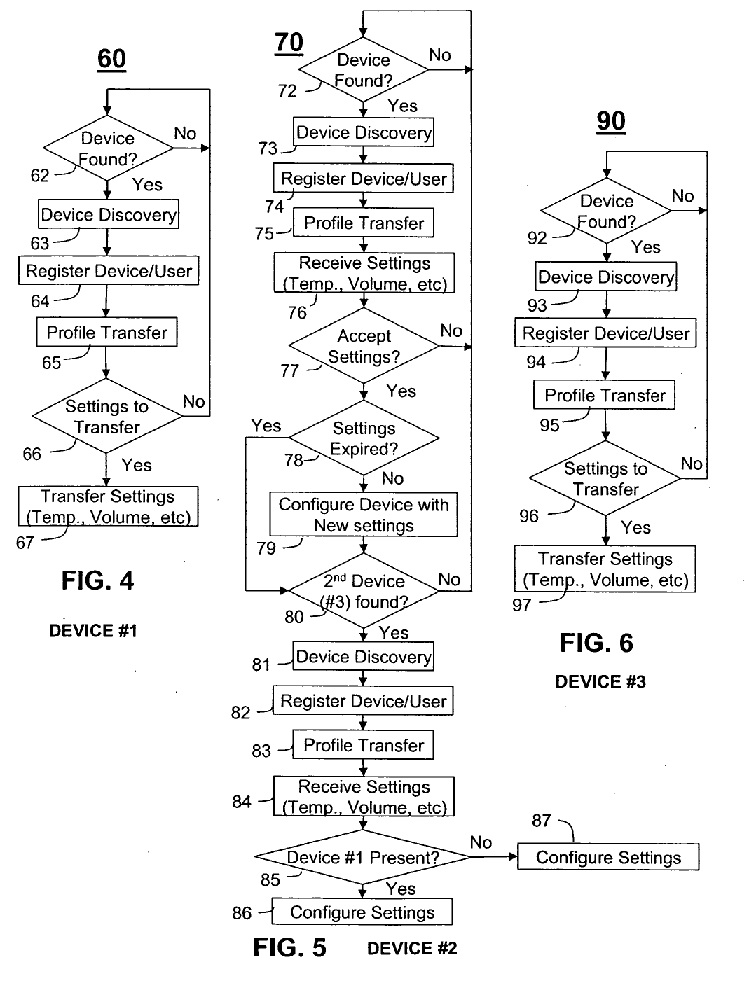

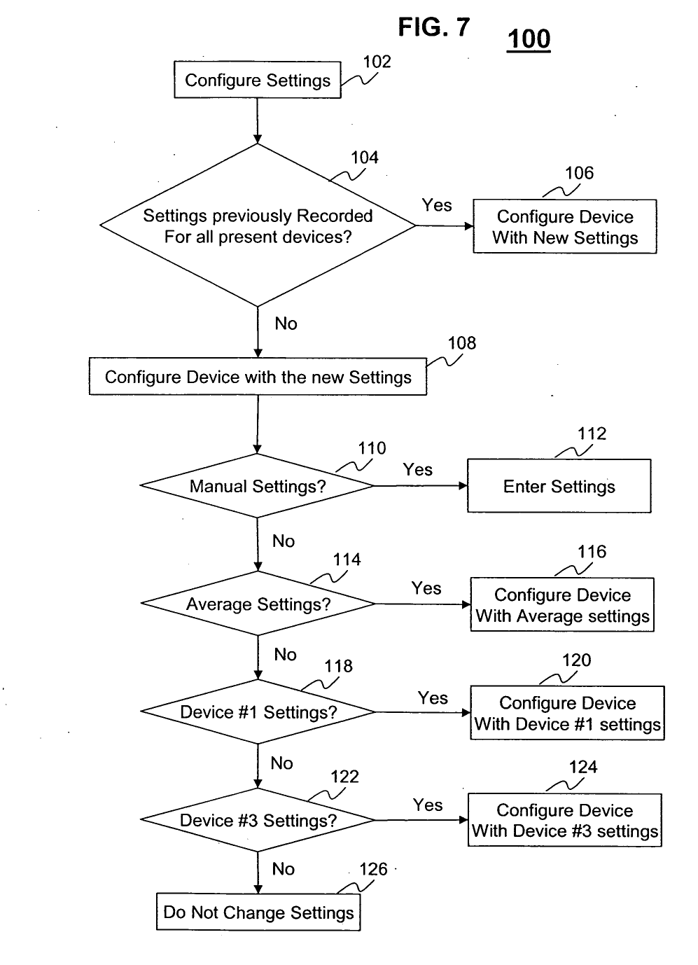

In one embodiment though, the data received by each of the devices can be used to make a decision collectively based on rules that a user can set up if desired. Referring to FIGS. 4, 5 and 6, methods 60, 70 and 90 illustrate such an interchange among a first, second and third device respectively. In method 60 at device #1, if another device is discovered at decision block 62, then device discovery 63, registration 64, and profile transfer 65 proceeds as previously described above. At decision block 66, if settings are ready to transfer, then settings data such as temperature, volume, etc. is transferred at step 67 in a media session for example. If no device is found at decision block 62 or if no settings needs transferring at decision block 66, then the method continues to poll for other devices at decision block 62. Similarly at a device #2, the method 70 determines if another device is discovered at decision block 72, then device discovery 73, registration 74, and profile transfer 75 proceeds as previously described above and the settings are received at step 76. At decision block 77, a determination is made whether the settings will be accepted and at decision block 78 a further determination is made whether an accepted setting is expired. If the settings are accepted at decision block 77 and not expired at decision block 78, then device #2 can be configured with new settings at step 79. If yet another device (device #3) is detected within the proximity at decision block 80, then device discovery 81, registration 82, and profile transfer 83 proceeds as previously described above and the settings are received at step 84. At decision block 85, a further inquiry is made whether device #2 is still in the presence of device #1 to ensure a collective configuration setting at either step 86 or step 87. If no device is found at decision block 72 or if no settings were accepted at decision block 77 or if no second device (#3) was found, then the method continues to poll for other devices at decision block 72. If settings are expired at decision block 78, then the method can continue to poll for the one or more devices at decision blocks 80 and 72).

Similarly at a device #3, the method 90 determines if another device (device #2) is discovered at decision block 92, then device discovery 93, registration 94, and profile transfer 95 proceeds as previously described above and then a determination is made whether settings are to be transferred at decision block 96. If there are no settings to transfer at decision block 96, then the method 90 continues to poll for devices at decision block 92. If settings are available for transfer, then such settings can be transferred at step 97 to device #2. Device #2 now has settings/preferences from both device #1 and device #3 and will operate accordingly (in accordance with rules that can be set at Device #2) whether it is in the presence of just Device #1 or just Device #3 or in the presence of both Devices #1 and #3.

In one specific example applying the methods 60, 70, and 90 above, a husband having device #1 and a wife having device #3 can approach a set top box acting as device #2. All the devices can interchange their respective information and all profiles can be updated. The set top box can adjust the volume matching the previously stored volume settings on the shared database created when the husband and wife having respective devices #1 and #3 were both previously within the proximity of device #2 or another rule taking an average or moving average can be use. In fact, any rule can be set to arbitrate the settings that can be set in the context of a changing environment with different users (forming different groups), preferences, and devices.

Each device can adapt its settings and/or behavior based on the devices (and registered users) in the surroundings. Again, when a user gets within range of different users, a user's profile can be shared or transferred among all the devices in the proximity. Each device can detect a user relation ship to create a group based on the profile of each user. Note, rules can set in many different ways, particularly rules for defining group preferences. For example, after a group has been identified, the device can set rules for the group where the rules can be pre-configured by a user, or learned from previous experiences and interactions, or configured as a default or standard (set of default rules when the group is not recognized), or rules can be defines by the exchanged profile.

To detect a group, each device in a potential group can exchange their profile as well as their ID. In one embodiment, the device can store the ID as well as the relationship (friend, family, spouse, girlfriend, boyfriend) associated with the user on the phone book. Groups can be detected from users listed on the phonebook or from profile information. Groups and their settings can be detected from profile information for example from devices sharing the same or similar profile, or from settings from past group encounters, or from the profile itself which can identify settings for a particular group.

In one specific example, when a user is in the proximity of their family, the device can configure and change the ring tones itself to match a family profile (more conservative ring tone), whereas when the user gets in contact with friends (e.g., at a bar) or coworkers (e.g., at the office or a conference), then the settings selected are more appropriate to the respective occasion. In yet another example, when a single device detects a group of friends (carrying a device) and a TV/set top box is also within range, all the devices can change the settings to the group settings (ring tones, favorites etc.) as well as the TV can adapt to the favorites settings (NFL channels, etc) arbitrated for the group setting. These examples concretely illustrate methods of exchanging and configuring information among devices when multiple users of a shared device are detected and present. They further illustrate how conflicts can be resolved when multiple devices are present and how groups and rules for such groups can be used for an enhanced shared user experience.

Note, the profile interchange could take place in many different ways. In a one to one interchange, it should be noted that certain devices have multiple owners or users (TVs, set-top boxes, etc.). In such instance, then the authentication can be created for each user to enable a data interchange only when the user of the user device is present (the user must do a manual configuration on the TV before using this feature, unless the TV can automatically discover the particular user from the user device). For example, a user leaves home wearing his or her cell phone and gets into their car. The car updates all the profile, tunes the radio to the same radio station as the user was listening on the radio (either on the cell phone or on a home entertainment system), or sets up the music based on the user profile. Before leaving the house, all the devices setup the recording times for the most watched TV networks on a recording device (DVR/VCR).

In a conditional interchange, data can be interchanged as requested. For example, in an interchange profile between husband and wife profile, upon the husband and wife coming within proximity of each other, they can share the profile information stored on both handheld devices if either the husband or wife requested it. The interchange can require a manual authentication from both sides.

In a manual interchange, the user must give his/her feedback to the device before interchanging profile data. For example, when a user buys a new phone, all the information can be transferred from one phone to another where the transfer is requested manually.

There are also instances where interchange with an other device is not possible. The interchange also can be setup to be one way only. In one example, a user rents a car and once he or she gets in, the car updates the profile based on the information carried by the user, but it does not share the cars profile with the user. In another example, a user visiting their child desires to watch all their favorites sporting events. A set top box at their child's house can download all the user's profile without necessarily storing it. The child's profile (from the set-top box or from other devices at the child's home) does not necessarily get downloaded to the user's (visiting parent's) handheld device.

In a more tailored fashion, a profile can be set up so the user can control what particular information can be shared as well as what to share according to the device or user in a profile level interchange. In one example, a husband and wife coming within proximity with each other can share profile information marked as “interchangeable” on both devices.

In an open interchange, a device will not require ownership; but will accept all profiles. In an open interchange scenario, there are several levels of open authentication. In a first case, the subject device will receive all device profiles, but will not interchange the learned capabilities with other devices (e.g., handheld device approaching a rental car). For example, when a user rents a car and once he or she gets in, the car updates the profile based on the information carried by the user, but it does not share the car's profile with the user. In a second case, the subject device will receive all device profiles, but will only interchange the learned capabilities since the last time that the particular owner of the subject device registered (e.g., the user travels to the same location and wants to learn the radio stations so next time that user travels to the same location all the information can be retrieved again with minimal or no user interaction). In a third case of an open interchange, there can be a limited interchange when a user gets in range, (e.g., when the user goes to visit relatives and logs into a set top box, the user might want to share his or her profile with respect to information useful for the set top box only). For example, a user visiting his daughter and desiring to watch the all his favorite sporting events can have a set top box at his daughter's house download his profile without necessarily storing it while his daughter's profile does not get downloaded to his handheld device.

In yet another example illustrating the seamless portability aspects herein, a user using an MP3 player on a mobile device can have a play list selected and activated in a session on the mobile device. When the mobile device comes within range of a different device (e.g., a home entertainment system) that can take a similar session, then the profile is interchanged (immediate data is interchanged with the profile). The profile is stored on the second device and the immediate data is acted upon at the new or different (or second) device. The second device takes the play list (immediate data) and selects this list and starts playing the play list or the particular song that was playing on the mobile device (e.g., by searching on a CD database at the home entertainment system and selecting the songs included on the play list). The immediacy data transfer is processed with or without local device storage. It is used to transfer the information related to the session that the user is involved on (Multimedia session—play list, songs playing, etc) to keep the experience going and hopefully seamless in most embodiments. The seamless profile portability helps a user to take the same radio station, media favorites, music or other desired characteristic when going from home to the car and to the office or among other environments. Using this method, the user devices can use a diverse set of user devices and environments for building user profiles overtime. Thereby, each user device becomes capable of providing and enhanced interface and experience in different contexts.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of collectively setting preferences among a plurality of electronic devices and a plurality of users, comprising the steps of:
collecting user preference data independently by the at least two among the plurality of electronic devices;
exchanging the user preference data among the plurality of electronic devices when at least two among the plurality of electronic devices are within a predetermined proximity;
forming a group user profile from the user data exchanged; and
arbitrating the parameters and settings in at least one among the plurality of electronic devices in accordance with the group user profile.

2. The method of claim 1, wherein the step of arbitrating the parameters and settings comprises the step of averaging the parameters and settings.

3. The method of claim 1, wherein the step of arbitrating the parameters and settings comprises at least one step among the step of maintaining an existing parameter setting and the step of matching parameters and settings to parameters and settings of one among the plurality of electronic devices.

4. The method of claim 1, wherein the step of collecting user preference data independently forms an individual user profile and wherein the step of arbitrating the parameters and settings comprises the step of providing a preference to the group user profile over the individual user profile.

5. The method of claim 1, wherein the step of arbitrating the parameters and settings comprises the step of adjusting the parameters and settings based on parameters and settings stored on a shared database among the plurality of electronic devices.

6. The method of claim 1, wherein the step of arbitrating the parameters and settings comprises the step of learning what parameters and settings a particular user prefers and replicating said parameters and settings when the plurality of electronic devices are within a predetermined proximity.

7. The method of claim 1, wherein the step of collecting user preference data comprises the step of collecting at least one among user content preferences, user habit preferences, user source preferences, and user device feature preferences.

8. The method of claim 7, wherein the step of collecting user preference data further comprises the step of collecting at least one among movie preferences, video series preferences, actor or actress preferences, movie producer preferences, movie studio preferences, volume preference, network preferences, user taste preferences, song preferences, radio station preferences, singer preferences, band preferences, music style preferences, web site preferences, temperature preferences, alarm setting preferences, chat buddies, and email list preferences.

9. The method of claim 1, wherein the step of forming the group user profile comprises the step creating rules for a predetermined group of users and wherein the step of arbitrating the parameters and settings arbitrates in accordance with a relationship among users in the predetermined group of users.

10. The method of claim 9, wherein the step of forming the group user profile comprises the step of creating rules for the predetermined group of users by using at least one among pre-configured rules by a user, learned rules from prior interactions between users, default rules, and exchanged profiles among users.

11. The method of claim 9, wherein the method further comprises the step of detecting a group by exchanging identifiers and profiles.

12. The method of claim 11, wherein the method further comprises the step of storing the identifier and a relationship associated with a user in a phone book.

13. The method of claim 12, wherein the step of detecting the group further comprises the step of identifying users in the phonebook having at least one among devices sharing a similar profile, settings from a past group encounter, and settings in a profile for an identified group.

14. An electronic device capable of setting preferences among a plurality of electronic devices and users collectively, comprising:
a processor coupled to the electronic device, wherein the processor is programmed to:
collect user preference data independently among the plurality of electronic devices;
exchange the user preference data among the plurality of electronic devices when at least two among the plurality of electronic devices are within a predetermined proximity;
form a group user profile from the user data exchanged; and
arbitrate the parameters and settings in at least one among the plurality of electronic devices in accordance with the group user profile.

15. The electronic device of claim 14, wherein the processor arbitrates the parameters and settings by performing at least one among averaging the parameters and settings, maintaining an existing parameter and setting, matching parameters and settings to parameters and settings of one among the plurality of electronic devices, adjusting the parameters and settings based on parameters and settings stored on a shared database among the plurality of electronic devices, learning what parameters and settings a particular user prefers and replicating said parameters and settings when the plurality of electronic devices are within a predetermined proximity or manually adjusting the parameters and settings.

16. The electronic device of claim 14, wherein the processor forms the group user profile by creating rules for a predetermined group of users.

17. The electronic device of claim 16, wherein the processor forms the group user profile by creating rules for the predetermined group of users by using at least one among pre-configured rules by a user, learned rules from prior interactions between users, default rules, and exchanged profiles among users.

18. The electronic device of claim 14, wherein the processor is further programmed to adjust the behavior of the electronic device based on a presence of another electronic device among the plurality of electronic devices and based on a relationship with a user thereof.

19. A machine readable storage, having stored thereon a computer program having a plurality of code sections executable by a machine for causing the machine to perform the steps of:
collecting user preference data independently by the machine for at least two among a plurality of electronic devices;
exchanging the user preference data among the plurality of electronic devices when at least two among the plurality of electronic devices are within a predetermined proximity;
forming a group user profile from the user data exchanged; and
arbitrating the parameters and settings in at least one among the plurality of electronic devices in accordance with the group user profile.

20. The machine readable storage of claim 19, wherein the computer program further has a plurality of code sections executable by the machine for causing the machine to perform the step of forming the group user profile by creating rules for a predetermined group of users by using at least one among pre-configured rules by a user, learned rules from prior interactions between users, default rules, and exchanged profiles among users.
